(19) United States
(12) Patent Application Publication
(10) Pub. No.: US 2020/0101612 A1
(43) Pub. Date: Apr. 2, 2020

(54) System for Autonomous Maintenance of a Motor Control Center and Switchgear Equipment

(71) Applicant: Rockwell Automation Technologies, Inc., Mayfield Heights, OH (US)

(72) Inventors: Corey A. Peterson, Grafton, WI (US); David C. Mazur, Mequon, WI (US)

(21) Appl. No.: 16/145,630

(22) Filed: Sep. 28, 2018

(51) Int. Cl. B25J 9/16; G05B 19/05; H02B 3/00

(52) U.S. Cl. CPC B25J 9/1679; G05B 19/058; G05B 2219/14006; H02B 3/00; B25J 9/163

(57) ABSTRACT

An autonomous machine is wirelessly controlled by a system controller in an industrial control environment, such as a factory with industrial processes and machines, to move to a coordinate location corresponding to a unit of a Motor Control Center (MCC) or Switchgear equipment supporting the industrial control system to maintain, repair, monitor and/or troubleshoot the equipment without the need to place a human operator in harm's way of energized circuits. The system controller, which could be a Programmable Logic Controller (PLC) controlling the industrial control system, can monitor operational statuses with respect to each unit, and can dispatch the autonomous machine as required. The autonomous machine can include a mechanical arrangement operable to connect and disconnect power with respect to a unit and/or to withdraw and replace a unit with respect to the equipment.

### FIELD OF THE INVENTION

The present invention relates generally to Motor Control Centers (MCC's) and Switchgear equipment, and more particularly, to a system for maintaining such equipment in which an autonomous machine moves in three dimensions with respect to the equipment and a system controller commands the autonomous machine to conduct mechanical operations for maintaining the equipment.

### BACKGROUND OF THE INVENTION

A wide range of applications exist for electrical enclosures and cabinets such as Motor Control Centers (MCC's) and Switchgear equipment. Such industrial control equipment is often used for distributing power and/or data in industrial control systems such as factories. This equipment typically comprises enclosures for both small and large individual units, such as for housing contactors and/or other switchgear. Larger enclosures are also common, such as for housing various power electronics equipment, control circuits, motor drives, and so forth. For instance, in industry it is common to find large enclosures divided into bays or segments for single and multi-phase switchgear, motor controllers, programmable logic controllers, data and power network interfaces, and so forth. This equipment can also include push buttons, indicator lights, variable-frequency drives, programmable logic controllers and/or metering equipment, and can be used to de-energize equipment to allow work to be done and to clear faults downstream.

Like other electrical components, equipment associated with MCC's and Switchgear may be susceptible to failures over time. Consequently, such equipment typically requires periodic maintenance to ensure units continue to operate correctly. However, one particular challenge in the maintenance of such equipment relates to the mechanical and thermal effects of internal arcing faults (also called an arc, arc fault, arc flash or arcing flash). In particular, certain types of electrical faults can produce arcs that can heat and even vaporize neighboring components and cause sudden pressure increases and localized overheating. The possibility of such arc fault conditions can render equipment maintenance a dangerous task, often requiring numerous safeguards before any such undertaking. Another challenge in the maintenance of such equipment is the difficulty in maneuvering in the tight quarters in which such equipment is often placed. What is needed is an improved way for maintaining such equipment which minimizes the dangers and/or difficulties associated with such maintenance.

### SUMMARY OF THE INVENTION

An autonomous machine is wirelessly controlled by a system controller in an industrial control environment, such as a factory with industrial processes and machines, to move to a coordinate location corresponding to a unit of a Motor Control Center (MCC) or Switchgear equipment supporting the industrial control system to maintain, repair, monitor and/or troubleshoot the equipment without the need to place a human operator in harm's way of energized circuits. The system controller, which could be a Programmable Logic Controller (PLC) controlling the industrial control system, can monitor operational statuses with respect to each unit, and can dispatch the autonomous machine as required. The autonomous machine can include a mechanical arrangement operable to connect and disconnect power with respect to a unit and/or to withdraw and replace a unit with respect to the equipment.

In one aspect, the invention can include a system or method to maintain, repair, monitor and or, troubleshoot MCC or Switchgear equipment without the need to place humans in harm's way of energized circuits. This can include but not limited to machine removal and/or replacement of units in an MCC that are in an “off” condition while other units around the off unit are still powered (in an “on” condition). A system or method for removal of units can use a quick disconnect electrical connection. This can be done, for example, with a split collet, fixed pin and/or socket implementation and/or any other type of connection that allows for un-tooled connection and disconnection. The ability to “know” where a unit location is in within three dimensional space of an MCC lineup can also be done through use of a database similar to IntelliCENTER as available from Rockwell Automation, Inc., an analytics edge engine and/or Artificial Intelligence (AI). The foregoing can be accomplished using a Global Positioning System (GPS) or other location tracking service with location coordinates externally mapped, like a site map, and/or internally mapped with location tags built into the units, so that data can be collected and/or updated in real time as units are replaced and/or moved, with a connection directly back to a database, analytic edge engine or AI. This could be limited in not only with respect to a factory floor, for example, but also with respect to an Electrical Equipment house or “E-House.” Predictive or pre-emptive analytics can be applied to determine potential failure of a unit. Accordingly, the machine can be used to manage good and problematic inventory on a factory floor or an E-House environment. On the factory floor, defined replacement locations can allow the machine to retrieve good units and a location defined to deposit failed or predicted or pre-emptive failure units. Autonomous machines could also monitor real-time thermal conditions and over time and suggest module movement to balance thermal loads. In addition, machine vision can be employed to help provide guidance for insertion and/or removal of units and provide a level and degree of safety. Tying this to a larger database or an AI can provide the machine with increasing capabilities. Such learning could be done in a cloud computing environment such that each machine can install and/or disconnect units that the machine had not previously installed or withdrawn. Once a unit of any type is installed anywhere, all machines can instantly determine how to install such units at any location.

Specifically then, one aspect of the present invention can provide a system for maintaining an MCC or Switchgear equipment, the equipment including multiple units for industrial control, each unit being configured to receive power from a common bus in the equipment, the system including: an autonomous machine configured to move in three dimensions with respect to the equipment, the autonomous machine having a processor, a wireless communication system, a location tracking system, and a mechanical arrangement operable to disconnect power with respect to a unit of the equipment; and a system controller executing a program stored in non-transient medium to: monitor an operational status with respect to each unit; and command the autonomous machine through the wireless communication system to move to a coordinate location corresponding to a unit of the equipment undergoing service and to disconnect power to the unit undergoing service. The operational status could include, for example, an indication of power being connected or disconnect with respect to the unit and/or an indication of a fault with respect to the unit.

Another aspect of the present invention can provide a method for maintaining an MCC or Switchgear equipment, the equipment including multiple units for industrial control, each unit receiving power from a common bus in the equipment, the method including: monitoring an operational status with respect to each unit; and commanding an autonomous machine through a wireless communication system, the autonomous machine moving in three dimensions with respect to the equipment using a location tracking system, the autonomous machine including a mechanical arrangement for disconnecting power with respect to a unit of the equipment, to move to a coordinate location corresponding to a unit of an equipment undergoing service and to disconnect power to the unit undergoing service.

These and other objects, advantages and aspects of the invention will become apparent from the following description. The particular objects and advantages described herein can apply to only some embodiments falling within the claims and thus do not define the scope of the invention. In the description, reference is made to the accompanying drawings which form a part hereof, and in which there is shown a preferred embodiment of the invention. Such embodiment does not necessarily represent the full scope of the invention and reference is made, therefore, to the claims herein for interpreting the scope of the invention.

### BRIEF DESCRIPTION OF THE DRAWINGS

Preferred exemplary embodiments of the invention are illustrated in the accompanying drawings in which like reference numerals represent like parts throughout, and in which:

FIG. 1 is an isometric view of exemplar industrial control electrical equipment for maintenance by an autonomous machine in accordance with an aspect of the invention;

FIG. 2 is an interior view of the equipment of FIG. 1;

FIG. 3 is schematic view of a system for maintaining electrical equipment using an autonomous machine in accordance with an aspect of the invention;

FIG. 4 is an isometric view an autonomous machine maintaining the equipment of FIG. 1 in accordance with an aspect of the invention;

FIG. 5 is an exemplar data structure illustrating mapping of units of the equipment in the system of FIG. 4 to coordinate locations and operational statuses, among other things, in accordance with an aspect of the invention; and

FIG. 6 is an exemplar data structure illustrating mapping of autonomous machines in the system of FIG. 4 to operations conducted with respect to units in the system, among other things, in accordance with an aspect of the invention.

### DETAILED DESCRIPTION OF THE OF THE INVENTION

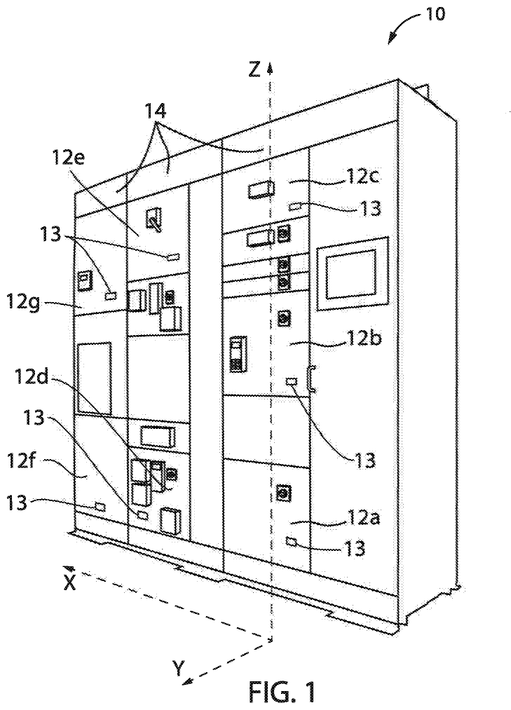

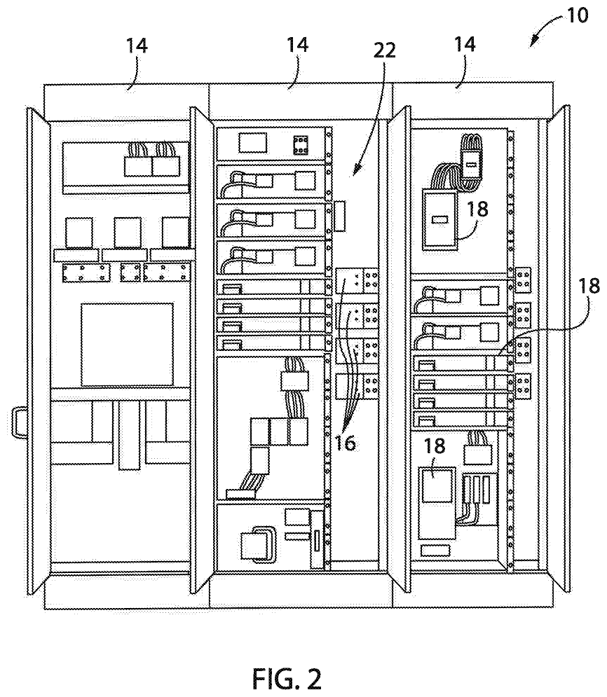

Referring now to FIGS. 1 and 2, exemplar electrical equipment 10, which could be a Motor Control Center (MCC) or Switchgear, includes multiple electrical units 12 of various types, such as first, second and third units 12a, 12b, 12c, respectively, housed in an enclosure or cabinet, for industrial control applications. In general, the equipment 10 can include one or more sections 14 or columns, each forming a shell around a device mounting volume for supporting the units 12. The shell may be made of any suitable material, such as heavy gage sheet metal, reinforced plastics, and so forth. The equipment 10 can receive multi-phase power (such as three-phase AC power) from an external power supply, such as a power supply grid, and/or data signals, via appropriate conduits (not shown), and distribute the received power and/or data signals to one or more of the sections 14 in various manners. The sections 14 may be electrically isolated from one another, or alternatively, may be electrically joined with other sections 14, such as via common horizontal power distribution bus bars 16. Exemplary equipment is also described in U.S. Pat. No. 8,638,561, entitled “Motor Control Center Unit Withdraw with Door Closed,” which document is incorporated herein by reference in its entirety.

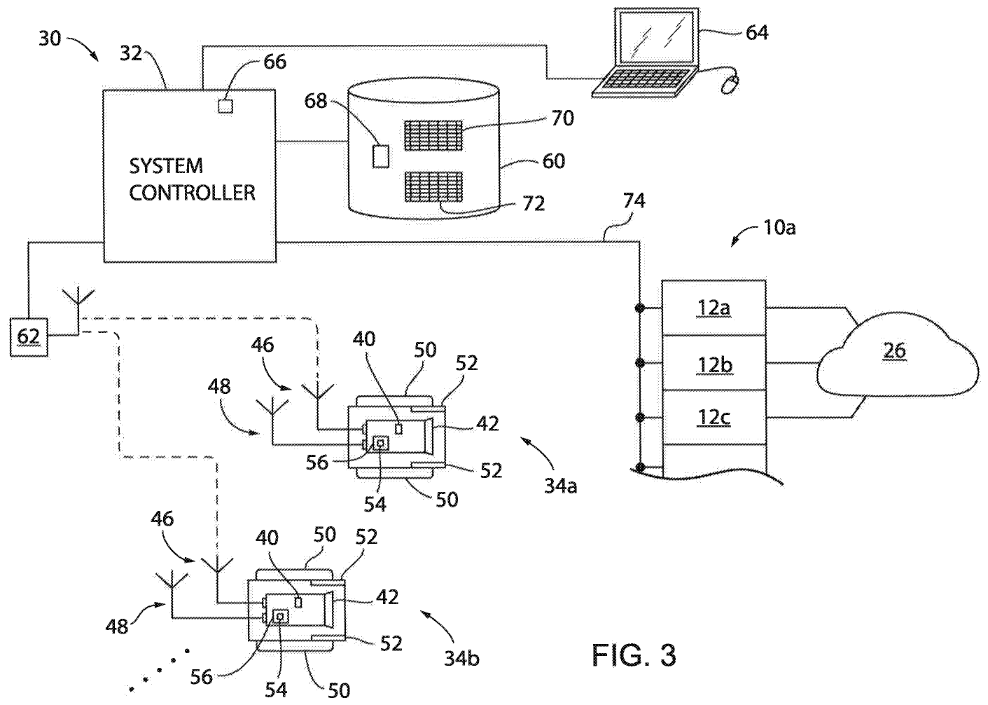

The units 12 may each include a door for covering an assembly of components 18 that are supported within each unit 12 via known methods, such as screwed (“fixed feed” or “frame mounted”) or snap-in (“withdrawable”) engagement, thereby providing mechanical and electrical connection to the equipment 10. Exemplary components 18 of the units 12 may include a starter, overload relay, motor drive or circuit breaker, and electrical control modules for controlling such components, such as a Programmable Logic Controller (PLC), among other things. Doors for the units 12 may include, for example, a lever (such as a rotary lever to turn ON and OFF a Circuit Breaker inside the unit and enabling opening of the door when the Circuit Breaker is OFF), a lock for preventing the door from opening, a light for indicating a safe condition for opening the door, and/or target indicia 13 for identifying the unit (such as a barcode, QR code and/or serial number). A latch rail (not shown) may be provided in each section 14 to interface with latches on the individual doors of the units 12. Accordingly, each unit 12 can be configured to receive power from a common bus in the equipment 10, such as by engagement with vertical power distribution bus bars connected to the horizontal power distribution bus bars 16. With additional reference to FIG. 3, each unit 12, in turn, could be connected to an industrial control process or machine 26 (which could be part of a factory) for variously powering and supporting the industrial process.

The sections 14 may also include wire-ways 20 in which line and load wiring, cabling and so forth may be installed to service the components 18. The sections 14 may optionally include preconfigured isolation areas 22 for variations in which greater electrical isolation between sections 14 is desired, such as in compliance with IEC 61439-2 Forms 3, 3a, 4 or 4b.

Referring now to FIG. 3, schematic view of a system 30 for maintaining the equipment 10, such as on a factory floor, in an Electrical Equipment house (“E-House”) or room with multiple MCC's and/or Switchgear equipment arranged in tight quarters, is provided in accordance with an aspect of the invention. The system 30 can include a system controller 32 and one or more autonomous machines 34 (such as first and second autonomous machines 34a and 34b, respectively, as shown).

Each autonomous machine 34 is configured to move in three dimensions with respect to the equipment 10, such as according to the multi-dimension, Cartesian axes (X, Y, Z) illustrated in FIG. 1. The autonomous machine 34 can comprise a processor 40, a Human Machine Interface (HMI) 42, a sensing arrangement 44, a wireless communication system 46, a location tracking system 48, a motion arrangement 50 and/or a mechanical arrangement 52. Accordingly, the processor 40 can execute a program 54 held in a data storage 56 of the autonomous machine 34 to execute maintenance operations as commanded using one or more of the aforementioned aspects of the machine. In particular, the HMI 42 can allow an operator to interact directly with the autonomous machine 34 for maintaining, monitoring and commanding the machine when it is proximal to the user. The sensing arrangement 44, which could include a camera providing machine vision, can allow the autonomous machine 34 to avoid obstacles when in motion, sense target indicia 13 for positively identifying a unit 12 undergoing service as indicated by a command, sense conditions of indicator lights of the unit 12 undergoing service to further confirm safe operation before handling, and/or provide guidance for insertion and/or removal of units 12. The wireless communication system 46 can allow an operator to interact indirectly with the autonomous machine 34 for maintaining, monitoring and commanding the machine when it is remote from a user, such as from the system controller 32. The wireless communication system 46 can enable various wireless, near field radio communication and/or Radio Frequency Identification (RFID) communications. The location tracking system 48 can allow the autonomous machine 34 to continuously determine its current physical location, and in particular, its location with respect to predetermined locations of the equipment 10 (in three dimensional space) stored in the machine. The location tracking system 48 could be part of a Global Positioning System (GPS) or other location tracking service. Accordingly, location coordinates can be externally mapped by the autonomous machine 34, like a site map, and/or internally mapped with location tags built into the units 12, so that data can be collected and/or updated in real time as units 12 are replaced and/or moved by the autonomous machine 34, with a connection directly back to the system controller 32.

The motion arrangement 50 can allow the autonomous machine 34 to move autonomously and wirelessly, and in particular, to move autonomously and wirelessly with respect to the equipment 10 in directions and angles which may be referenced by the Cartesian axes (X, Y, Z) on a factory floor or E-House. The mechanical arrangement 52 is operable to allow the autonomous machine 34 to directly interact with units 12 undergoing service, such as a mechanical arm operable to connect or disconnect power with respect to a unit 12 (such as actuating a lever to turn ON or OFF a Circuit Breaker inside the unit), to withdraw a unit 12 partially or fully from the equipment 10 (such as opening a lock and/or door, disconnecting a split collet, fixed pin and/or socket implementation and/or other un-tooled connection, and pulling the unit away from the equipment 10), and/or to replace a unit 12 with a different (replacement) unit 12.

The system controller 32 can be connected to system storage 60 and a controller communication device 62. In one aspect, the system controller 32 can also be in communication with the one or more units 12 of the equipment 10, such as for monitoring the units 12 and/or controlling aspects of the industrial control process or machine 26 through the units 12. In particular, the system controller 32 could be a Programmable Logic Controller (PLC). The system controller 32 can also be in communication a computer terminal 64 providing an with an I/O interface for controlling the system 30 and, as a result, aspects of the industrial control process or machine 26. The system controller 32 can comprise a processor 66 executing a program 68 which could be stored in the system storage 60. The program 68 can reference unit and machine data structures 70 and 72, respectively, to monitor operational statuses of the units 12 and command the autonomous machines 34. In particular, the system controller 32 can execute to monitor operational statuses of the units 12, including indications of power being connected or disconnect with respect to the unit 12, and/or indications of faults, through monitor lines 74 (which may be connected to components 18 of the units 12). The system controller 32 can also execute to wirelessly command one or more of the autonomous machines 34, through the controller communication device 62 to the wireless communication system 46, to move to a coordinate location corresponding to a unit 12 of the equipment 10 undergoing service. The system controller 32 can further command the autonomous machines 34, for example: to disconnect power to the unit 12 undergoing service; to withdraw the unit 12 partially or completely from the equipment 10; to replace the unit 12 undergoing service with a different unit 12′; and/or to connect power to the unit 12 undergoing service (or the different unit 12′). Also, the system controller 32 can advantageously command the autonomous machines 34 to variously conduct one or more of the aforementioned operations while other units 12 of the equipment 10, including adjacent units 12 of the equipment 10, are continuously connected to power and operating to control the industrial control process or machine 26. Moreover, the system controller 32 can advantageously coordinate locations and commands of multiple autonomous machines 34 to efficiently resolve and/or avoid faults.

In one aspect, the autonomous machines 34 could be assigned by the system controller 32 to separately maintain their own equipment 10, such as the first autonomous machine 34a being assigned to maintain the first equipment 10a, while the second autonomous machine 34b is assigned to maintain the second equipment 10b. Moreover, movement of the autonomous machines 34 can be bounded by geo-fences to avoid crossing into one another's zones, such as the first autonomous machine 34a being bounded by a first geo-fence containing the first equipment 10a, while the second autonomous machine 34b is bounded by a second geo-fence containing the second equipment 10b.

the first and second autonomous machines are bounded by first and second geo-fences containing the first and second equipment, respectively

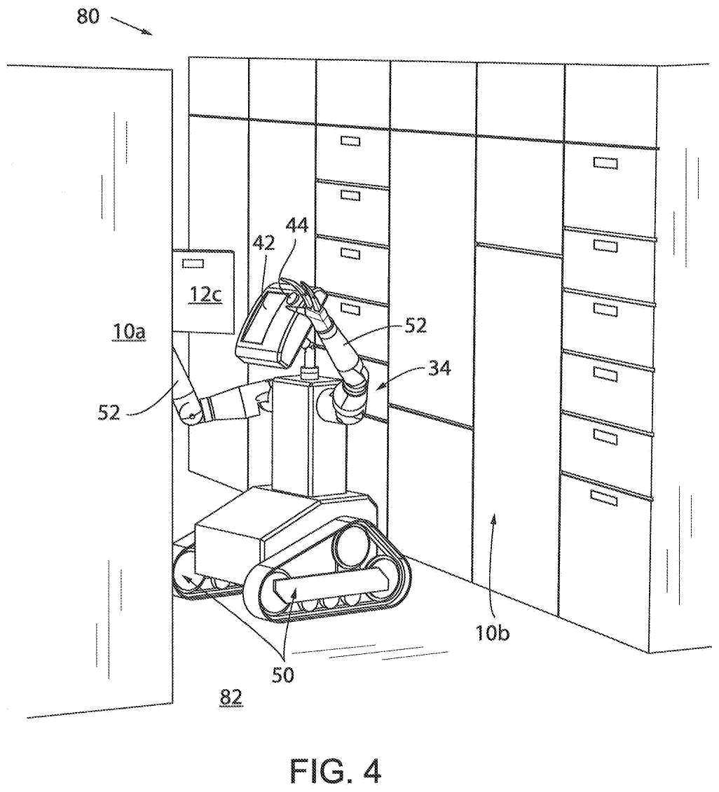

By way of example, with additional reference to FIG. 4, for an operation in which a unit 12 is removed (in this case unit 12c), an exemplar autonomous machine 34 can be commanded by the system controller 32 to move freely in on a factory floor or E-House 80, along a floor 82, to an X-Y coordinate location in a plane of the floor 82 corresponding to a commanded location in front of a section 14 containing the unit 12 undergoing service (unit 12c of a first equipment 10a). The autonomous machine 34 can move to the commanded location, in paths while avoiding obstacles, such as other equipment 10, using the sensing arrangement 44 and the motion arrangement 50. In particular, the autonomous machine 34 can complete such motion without collision by using the sensing arrangement 44 to continuously detect obstacles in its path while continuously determining its optimum path to the commanded location while in motion. In another aspect, the autonomous machine 34 can complete such motion without collision by continuously referencing predetermined paths and/or predetermined locations of obstacles between its current location and the commanded location stored in the data storage 56 and moving along such paths, halting if obstacles are sensed, and adjusting to revised paths.

At the commanded location, the autonomous machine 34 can raise to a Z coordinate in a plane perpendicular to the floor 82, corresponding to a location in front of the particular unit 12 undergoing service, here the unit 12c. The autonomous machine 34 can raise to the Z coordinate by extension of the motion arrangement 50 in the Z direction and/or by actuation of the mechanical arrangement 52. Then, the autonomous machine 34 can sense target indicia 13 of the unit 12c undergoing service for positively identifying the unit as indicated by the command, using the sensing arrangement 44. The autonomous machine 34 can then actuate the mechanical arrangement 52 to disconnect power to the unit 12c undergoing service, and then withdraw the unit 12c from the first equipment 10a, partially or completely. Moreover, the autonomous machine 34 can be commanded remove the unit 12c while other units 12 of the equipment 10, including unit 12a and adjacent unit 12b, are continuously connected to power and operating to control the industrial control process or machine 26. Accordingly, use of the autonomous machine 34 in this way can avoid the need to place a human operator in harm's way of energized circuits of the equipment 10 on the factory floor or E-House 80.

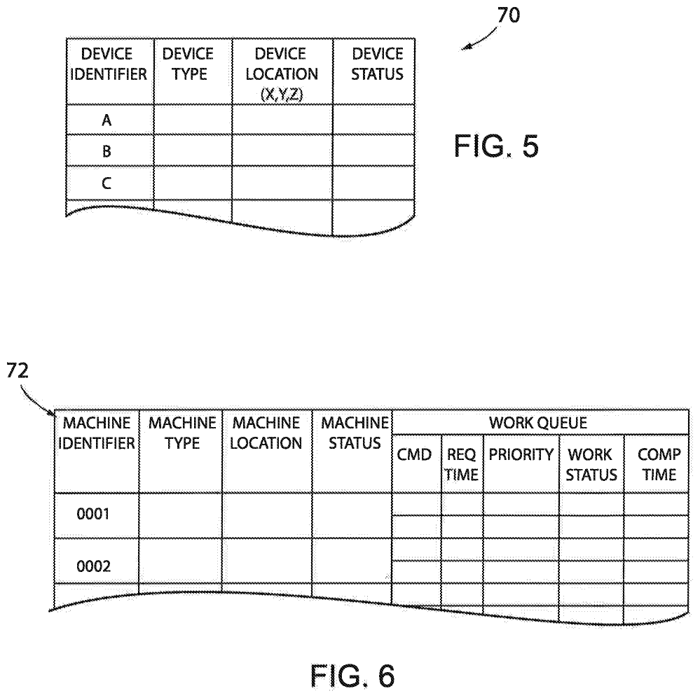

With additional reference to FIG. 5, an exemplar unit data structure 70 which can be referenced by the system controller 32 is provided in accordance with an aspect of the invention. The unit data structure 70 can map each unit 12, indicated by a “Device Identifier,” such as unit “A,” unit “B,” unit “C,” and so forth, of the equipment 10 in the system 30, to a “Device Type,” “Device Location” and/or “Device Status.” The Device Type can indicate a type of device corresponding to unit 12, such as including an electrical control module, starter, overload relay, motor drive or circuit breaker, among others. The Device Location can indicate a typically static coordinate location of the unit, such as Cartesian coordinates (X, Y, Z) on the factory floor or E-House 80. The Device Status can indicate a typically dynamic operational status with respect to each unit, such as an indication of power being connected or disconnect with respect to the unit, and/or indication of a fault, which could be signaled through monitor lines 74. Mapped parameters of the unit data structure 70 can be referenced by a user through the computer terminal 64 for commanding autonomous machines 34 to respond to numerous issues, such as to maintain, repair, monitor and/or troubleshoot equipment.

With additional reference to FIG. 6, an exemplar machine data structure 72 which can be referenced by the system controller 32 is provided in accordance with an aspect of the invention. The machine data structure 72 can map each autonomous machine 34, indicated by a “Machine Identifier,” such as machine “0001,” machine “0002,” and so forth, in the system 30, to a “Machine Type,” “Machine Location,” “Machine Status” and/or a “Work Queue.” The Machine Type can indicate a type of machine corresponding to the autonomous machine 34 for an indication of its capabilities. The Machine Location can indicate a typically dynamic coordinate location of the machine, such as Cartesian coordinates (X, Y, Z) in the E-House or room, periodically updated as the machine moves. The Machine Status can indicate a status with respect to each machine, such as an indication of being in an offline mode (incapable of being commanded), an online/idle mode (ready to be commanded) and/or an online/dispatched mode (executing commands according to its work queue). The Work Queue can indicate multiple commands indicated by “Command (CMD)” type in a queue. Each command can indicate, for example, an operation conducted with respect to a unit 12. In addition, each Command can be mapped to a “Request Time (Req. Time),” “Priority,” “Work Status” and/or a “Completion Time (Comp. Time).” The Commands could include, for example, resetting a unit, disconnecting power to a unit, partially removing a unit, completely removing a unit, transporting a unit to a repository, installing a replacement unit, and/or connecting power to a unit, The Request Time can provide a logged time in which the system controller 32 queued the command, such as upon receipt from the computer terminal 64. The Priority can provide a relative importance for the command for prioritizing execution of the command with respect to other commands in the Work Queue. The Work Status can indicate a current status of the command, such as a command being pending, active or complete. The Completion. Time can provide a logged time in which execution of the command is complete by the autonomous machines 34.

In addition, the system controller 32 can use predictive analytics to determine potential failures of units 12. Also, the system controller 32 and/or autonomous machines 34 can utilize AI to provide maintenance operations with increasing capabilities. As a result, the system controller 32 and the autonomous machines 34 can provide an effective system to manage good and problematic inventory on the factory floor or E-House 80.

The present invention may be part of a “safety system” used to protect human life and limb in a field, construction or other environment. Nevertheless, the term “safety,” “safely” or “safe” as used herein is not a representation that the present invention will make the environment safe or that other systems will produce unsafe operation. Safety in such systems depends on a wide variety of factors outside of the scope of the present invention including: design of the safety system, installation and maintenance of the components of the safety system, and the cooperation and training of individuals using the safety system. Although the present invention is intended to be highly reliable, all physical systems are susceptible to failure and provision must be made for such failure.

Certain terminology is used herein for purposes of reference only, and thus is not intended to be limiting. For example, terms such as “upper,” “lower,” “above,” and “below” refer to directions in the drawings to which reference is made. Terms such as “front,” “back,” “rear,” “bottom,” “side,” “left” and “right” describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first,” “second” and other such numerical terms referring to structures do not imply a sequence or order unless clearly indicated by the context.

When introducing elements or features of the present disclosure and the exemplary embodiments, the articles “a,” “an,” “the” and “said” are intended to mean that there are one or more of such elements or features. The terms “comprising,” “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as coming within the scope of the following claims. All of the publications described herein including patents and non-patent publications are hereby incorporated herein by reference in their entireties.

What is claimed is:

1. A system for maintaining a Motor Control Center (MCC) or Switchgear equipment, the equipment comprising a plurality of units for industrial control, each units being configured to receive power from a common bus in the equipment, the system comprising:
an autonomous machine configured to move in three dimensions with respect to the equipment, the autonomous machine having a processor, a wireless communication system, a location tracking system and a mechanical arrangement operable to disconnect power with respect to a unit of the equipment; and
a system controller executing a program stored in non-transient medium to:
monitor an operational status with respect to each unit; and
command the autonomous machine through the wireless communication system to move to a coordinate location corresponding to a unit of the equipment undergoing service and to disconnect power to the unit undergoing service.

2. The system of claim I, wherein the mechanical arrangement is further operable to withdraw the unit at least partially from the equipment.

3. The system of claim 2, wherein the system controller commands the autonomous machine to disconnect power to the unit undergoing service and at least partially withdraw the unit undergoing service from the equipment while at least one unit that is adjacent to the unit undergoing service is continuously connected to power.

4. The system of claim 2, wherein the mechanical arrangements further operable to replace the unit undergoing service with a different unit.

5. The system of claim 1, wherein each unit contains an electrical control module, and wherein the unit undergoing service contains an electrical control module for controlling a starter, overload relay, motor drive or circuit breaker.

6. The system of claim 1, wherein the system controller comprises a Programmable Logic Controller (PLC) configured to control an industrial process or machine through the plurality of units.

7. The system of claim 1, wherein the autonomous machine is a first autonomous machine, and further comprising a second autonomous machine, wherein the first and second autonomous machines are assigned by the system controller to maintain first and second equipment, respectively.

8. The system of claim 7, wherein the first and second autonomous machines are bounded by first and second geo-fences containing the first and second equipment, respectively.

9. The system of claim 1, wherein the system controller maintains a data structure mapping each unit to its coordinate location and its operational status.

10. The system of claim 9, wherein the autonomous machine is a first autonomous machine, and further comprising a second autonomous machine, wherein the system controller further maintains a data structure mapping each autonomous machine to an operation conducted with respect to a unit.

11. The system of claim 10, wherein the autonomous machine further comprises a Human Machine Interface (HMI) is configured to receive commands directly from an operator.

12. The system of claim 1, wherein the equipment is divided into a plurality of sections with each section including a plurality of units vertically arranged in the section, and wherein the coordinate location comprises first and second Cartesian coordinates corresponding to an “X, X” location of a section and a third Cartesian coordinate corresponding to a “Z” location of a unit in the section.

13. The system of claim 12, wherein the location tracking system is a Global Positioning System (GPS).

14. A method for maintaining a Motor Control Center (MCC) or Switchgear equipment, the equipment comprising a plurality of units for industrial control, each unit receiving power from a common bus in the equipment, the method comprising:
monitoring an operational status with respect to each unit; and
commanding an autonomous machine through a wireless communication system, the autonomous machine moving in three dimensions with respect to the equipment using a location tracking system, the autonomous machine including a mechanical arrangement for disconnecting power with respect to a unit of the equipment, to move to a coordinate location corresponding to a unit of an equipment undergoing service and to disconnect power to the unit undergoing service.

15. The method of claim 14, further comprising commanding the autonomous machine to withdraw the unit at least partially from the equipment.

16. The method of claim 15, further comprising commanding the autonomous machine to disconnect power to the unit undergoing service and at least partially withdraw the unit undergoing service from the equipment while at least one unit that is adjacent to the unit undergoing service is continuously connected to power.

17. The method of claim 15, further comprising commanding the autonomous machine to replace the unit undergoing service with a different unit.

18. The method of claim 14, wherein the autonomous machine is a first autonomous machine, and further comprising assigning the first autonomous machine and a second autonomous machine to maintain first and second equipment, respectively.

19. The method of claim 14, further comprising maintaining a data structure mapping each unit to its coordinate location and its operational status.

20. The method of claim 14, wherein the autonomous machine is a first autonomous machine among a plurality of autonomous machines, and further comprising maintaining a data structure mapping each autonomous machine to an operation conducted with respect to a unit.
